(19) United States
(12) Patent Application Publication
(10) Pub. No.: US 2018/0073356 A1
(43) Pub. Date: Mar. 15, 2018

(54) SINGLE THREAD FIBER OPTIC TRANSMISSION

(71) Applicant: Schlumberger Technology Corporation, Sugar Land, TX (US)

(72) Inventors: Santiago Hassig Fonseca, Sugar Land, TX (US); Jordi Juan Segura Dominguez, Richmond, TX (US); Pierre Ramondenc, Sugar Land, TX (US)

(21) Appl. No.: 15/816,180

(22) Filed: Nov. 17, 2017

Related U.S. Application Data
(63) Continuation-in-part of application No. 15/008,172, filed on Jan. 27, 2016.

(51) Int. Cl. E21B 47/12; H04B 10/25

(52) U.S. Cl. CPC E21B 47/123; H04B 10/25

(57) ABSTRACT

A system for managing multiple transmissions over a single fiber optic thread at an oilfield. The system includes surface equipment and a downhole device coupled to the equipment by way of the fiber optic thread. The types of transmissions may be telemetric or even optical power. Additionally, the transmissions may be one-way or two-way in nature between the equipment and the downhole device. Additionally, unique platform layouts may be employed for sake of managing different transmission types in different ways, for example, during coiled tubing operations.

### CROSS REFERENCE TO RELATED APPLICATION

This Patent Document is a Continuation-In-Part claiming priority under 35 U.S.C. § 120 to U.S. application Ser. No. 15/008,172, entitled “Fiber Optic Coiled Tubing Telemetry Assembly”, filed Jan. 27, 2016, which is incorporated herein by reference in its entirety.

### BACKGROUND

Exploring, drilling and completing hydrocarbon and other wells are generally complicated, time consuming and ultimately very expensive endeavors. In recognition of these expenses, added emphasis has been placed on efficiencies associated with well completions and maintenance over the life of the well. Along these lines, added emphasis has been placed on well logging, profiling and monitoring of conditions from the outset of well operations. Whether during interventional applications or at any point throughout the life of a well, detecting and monitoring well conditions has become a more sophisticated and critical part of well operations and maintenance.

Such access to the well is often provided by way of coiled tubing. Coiled tubing may be used to deliver interventional or monitoring tools downhole and it is particularly well suited for being driven downhole through a horizontal or tortuous well, to depths of perhaps several thousand feet, by an injector head at the surface of the oilfield. Thus, with these characteristics in mind, the coiled tubing will also generally be of sufficient strength and durability to withstand such applications.

In addition to providing access generally, coiled tubing may be utilized as a platform for carrying passive sensing capacity. For example, a fiber optic line may be run through the coiled tubing interior and utilized to acquire temperature and acoustic information from within the well. This is often referred to as providing, among other types of distributed measurements, distributed temperature sensing (DTS) and/or heterodyne distributed vibration sensing (hDVS) capacity. In this manner, the deployment of coiled tubing into the well for a given application may also result in providing such additional information in a relatively straight forward manner without any undue requirement for additional instrumentation or effort.

By the same token, given the capacity of the coiled tubing to carry a telemetric line, fiber optics may be utilized for sake of communication, for example, between oilfield equipment and a downhole application tool (e.g. at the bottom end of the coiled tubing). That is, while a more conventional electric cable may also be utilized for communications, there may be circumstances where a fiber optic line is preferred. For example, an electric cable capable of providing two-way communications between oilfield equipment and a downhole application tool may be of comparatively greater size, weight, and slower communication speeds as compared to a fiber optic telemetric line. This may not be of dramatic consequence when the application run is brief and/or the well is of comparatively shallower depths, say below about 10,000 feet. However, as wells of increasingly greater depths and deviation, such as beyond about 20,000 feet or so with a horizontal completion, become more and more common, the difference in time required to run the application as well as the weight of the extensive electrical cable may be quite significant. In some cases it may simply be impossible to use a coiled tubing unit equipped with electrical cable. The comparative greater size and weight of the electric cable may also further complicate installation and maintenance of the electric line as compared to fiber optics.

As alluded to above, utilizing a fiber optic line in place of an electric cable may increase communication or data transmission rates as well as reduce the weight of the overall deployed coiled tubing assembly. Once more, a fiber optic line may be more durable than the electric cable in certain respects. For example, where the application to be carried out downhole involves acid injection for sake of cleaning out a downhole location, acid will be pumped through the coiled tubing coming into contact with the telemetric line therethrough. In such circumstances, the line may be more resistant to acid where fiber optics are utilized for the telemetry, given the greater susceptibility of electric lines to damage upon acid exposure due to manner of construction.

In spite of the variety of advantages, utilizing a fiber optic line to provide telemetry through the coiled tubing in lieu of an electric line does present certain challenges. For example, given the more common deeper wells of today, it is likely that the fiber optic line would be of an extensive length and require a heat resistant capacity. Indeed, high temperature fiber optic lines are available which are rated for use at over 150° C. However, such fiber optic lines are substantially more expensive on a per foot basis. Once more, with well depths commonly exceeding 20,000 feet and susceptible to extreme temperatures, this means that the line cost is likely to be very expensive. By way of example, in today's dollars it would not be uncommon to see a 22,000 foot fiber optic line with two-way communications approach about $250,000 in cost. Adding to the cost is the fact that with multiple threads, the risk of introducing a defect to the line is increased with every thread that is added to the line. A single defect in a single thread may render the entire line to be of no value. Additionally, fiber optic threads, regardless of type tend to deteriorate over time and use and generally will require replacement before other equipment parts.

In an effort to reduce the cost of a fiber optic line through a coiled tubing as described above, it is feasible to eliminate certain threads of the line. That is, a conventional two-way fiber optic line would include multiple fiber optic threads. Specifically, one or more threads may provide a downlink for data from the oilfield surface, for example to command one or more downhole tools, whereas one or more threads would provide an uplink for data back to the surface from the one or more tools. Thus in theory, for two-way fiber optic communication, the total threads may be reduced to a total of no more than two (e.g. one dedicated for downlink and the other for uplink).

While some cost reduction might be seen in reducing the number of fiber optic threads perhaps by as much as $60,000 per thread eliminated in the 22,000 foot example, the ability to reduce the line down to a single fiber may not be a practical undertaking at present. For example, it might be feasible to utilize the dedicated thread for uplink communications from the tool and send downlink commands through another mode such as pressure pulse actuation. However, this would result in a downlink signal that might be of poorer quality and require its own dedicated surface controls, therefore driving up equipment cost. Thus, as a practical matter, coiled tubing operators are generally left with the option of either more expensive fiber optic communications or less desirable electric communications.

### SUMMARY

A system for use with a well is disclosed. The system utilizes surface equipment positioned at an oilfield adjacent the well. A downhole device is positioned in the well with a fiber optic thread coupled to each of the surface equipment and the downhole device. The thread is further configured to accommodate first and second fiber optic transmissions to one of the equipment and the device. Further, these transmissions are different types of fiber optic transmissions.

### BRIEF DESCRIPTION OF THE DRAWINGS

FIG. 1 is a schematic view of an embodiment of a system with a single fiber optic thread supporting transmissions of multiple types between surface equipment and a downhole device.

FIG. 2A is a perspective view of surface and downhole coupler housings for use with the surface equipment and downhole device of FIG. 1.

FIG. 2B is a schematic view of the system of FIG. 1 detailing two way transmission paths for the transmissions by way of the couplers of FIG. 2A.

FIG. 3A is a schematic view of an alternate embodiment of a system with a single fiber optic thread supporting multiple transmission types including one-way transmissions.

FIG. 3B is a schematic view of another embodiment of a system with a single fiber optic thread supporting multiple transmission types and split routing of transmissions.

FIG. 3C is a schematic view of another embodiment of a system with a single fiber optic thread supporting multiple transmission types including optical power transmissions.

FIG. 4A is a schematic view of another embodiment of a system with a single fiber optic thread supporting multiple transmission types with series couplers for channel segregation.

FIG. 4B is a schematic view of the channel segregation of FIG. 4A applied to coiled tubing application equipment.

FIG. 5 is an overview of an oilfield with the coiled tubing of FIG. 4B in a well for an application utilizing a single fiber optic thread system supporting multiple transmission types.

FIG. 6 is a flow-chart summarizing an embodiment of an application utilizing a system in a well with a single fiber optic thread to support multiple fiber optic transmission types.

### DETAILED DESCRIPTION

In the following description, numerous details are set forth to provide an understanding of the present disclosure. This includes description of the surrounding environment in which embodiments detailed herein may be utilized. In addition to the particular surrounding environment detail provided herein, that of U.S. Pat. Nos. 7,515,774 and 7,929,812, each for Methods and Apparatus for Single Fiber Optical Telemetry may be referenced as well as U.S. application Ser. No. 14/873,083 for an Optical Rotary Joint in Coiled Tubing Applications, each of which is incorporated herein by reference in their entireties. Additionally, it will be understood by those skilled in the art that the embodiments described may be practiced without these and other particular details. Further, numerous variations or modifications may be employed which remain contemplated by the embodiments as specifically described.

Embodiments are described with reference to certain tools and applications run in a well over coiled tubing. The embodiments are described with reference to a particular cleanout applications utilizing acid and a cleanout tool at the end of a coiled tubing line. However, a variety of other applications may take advantage of well system embodiments as detailed herein. For example, permanent completions, alternate conveyances such as slickline and wireline cables and even cables for downhole electrical submersible pumps. Indeed, so long as the system includes surface and/or downhole assemblies with a fiber optic thread therebetween which accommodates multiple types of fiber optic transmissions, appreciable benefit may be realized.

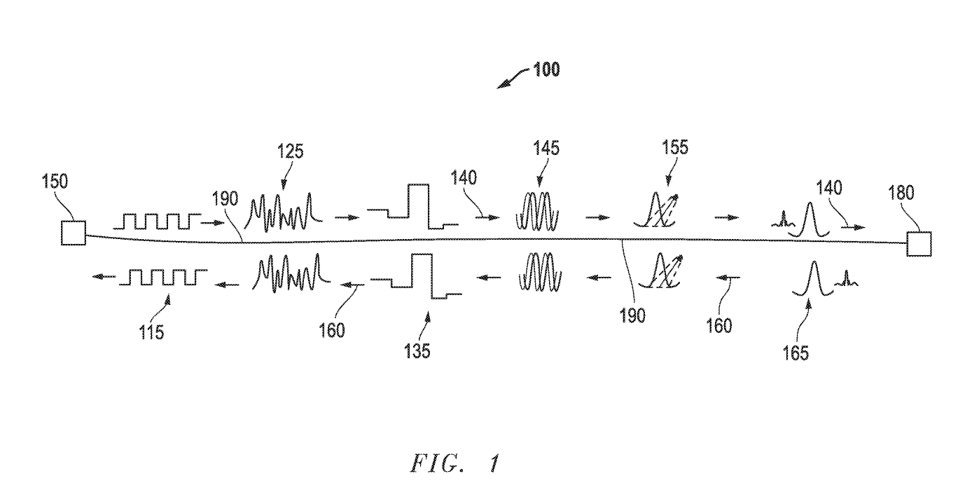

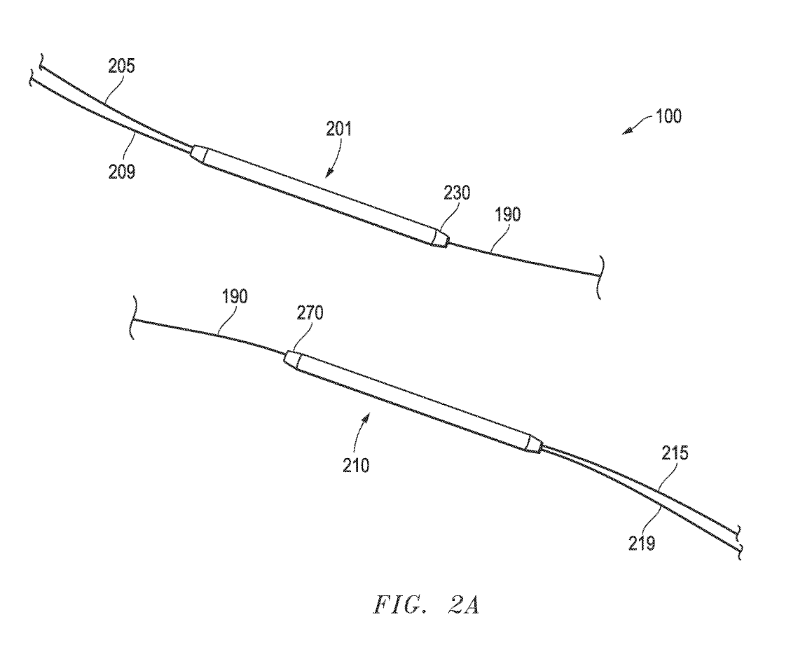

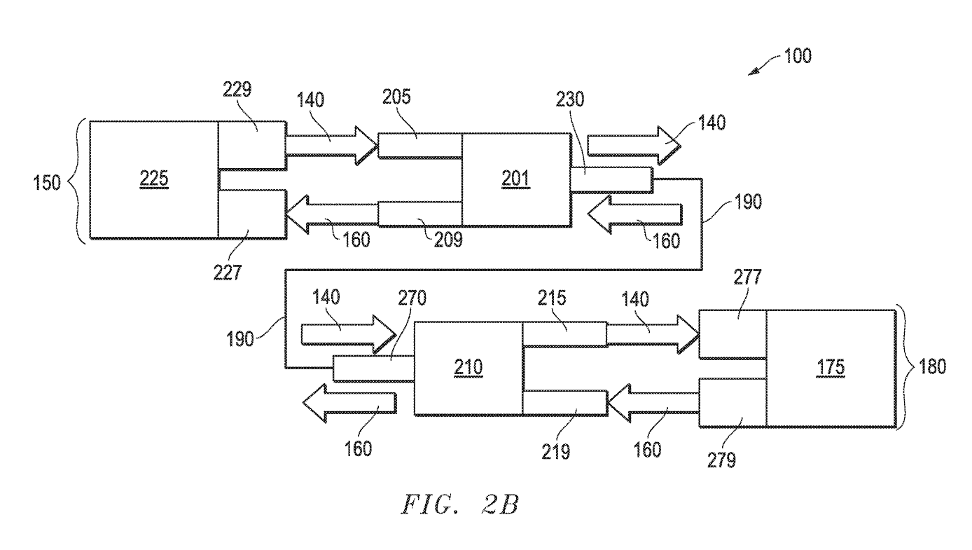

Referring specifically now to FIG. 1, a schematic view of an embodiment of a system 100 is shown with a single optical fiber or fiber optic thread 190 supporting transmissions 115, 125, 135, 145, 155, 165 of multiple types between surface equipment 150 and a downhole device 180. The thread 190 may be single or multi-mode. As illustrated in greater detail below with reference to FIG. 2B, these transmissions 115, 125, 135, 145, 155, 165 may be two way. That is, they may be directed over the thread 190 from the surface equipment 150 toward the downhole device 180 in a downhole direction (see downlink arrows 140). By the same token, they may be directed over the thread 190 from the downhole device 180 toward the surface equipment 150 in an uphole direction (see uplink arrows 160).

The different types of transmissions 115, 125, 135, 145, 155, 165 which may be accommodated by the fiber optic thread 190 may include digital transmissions 115, analog transmissions 125, optical power transmissions 135, wavelength shifting transmissions 145, phase changing transmissions 155 and/or distributed measurement transmissions 165, to name a few. Regardless, utilizing different types of optical transmissions 115, 125, 135, 145, 155, 165 provides an added degree of capacity or flexibility for the system 100. For example, as detailed below, two-way communications over the single thread 190 may be enhanced by using different wavelengths for downlink transmissions 140 than that used for uplink transmissions 160. By the same token, regardless of downlink 140 or uplink 160 status, the number of different transmissions that may be sent over the thread 190 simultaneously, even in the same direction, may be increased by the number of different optical transmissions types 115, 125, 135, 145, 155, 165 available.

As used herein, the term different “transmission types” is not meant to infer that any non-optical transmissions are taking place. These transmissions 115, 125, 135, 145, 155, 165 are all optical in nature over a fiber optic thread 190. However, the manner in which these transmissions 115, 125, 135, 145, 155, 165 are emitted and/or dealt with at each end of the thread 190 may be different from one transmission type to another. That is, as described below, a distributed measurement tool of surface equipment 150 may be tailored to monitor backscattered bursts of light. Thus, a dedicated channel of detection for distributed measurement transmissions 165 is provided. On the other hand, a digital transceiver of the surface equipment 150 may be tuned to a specific range of wavelengths as a channel for instructing a downhole tool or obtaining well information (e.g. via digital transmission 115). Digital transmissions 115 may be well suited for such binary communications. Of course, both transmissions 115, 165 are fiber optic. However, due to the different types of devices transmitting and receiving the information, different dedicated channels are available. As a result, the system 100 supports independent information streams that may enable hardware, software and firmware to operate independently without requiring costly development of overall inter-operability in design.

Continuing with reference to FIG. 1, where multiple different downhole devices are to be employed downhole, in addition to, and/or including the depicted device 180, each such device may utilize a different type of optical transmission 115, 125, 135, 145, 155, 165 for communication with the surface equipment 150 as suggested above. In a more specific example, temperature information may be conveyed to the surface equipment 150 over the thread 190 by way of a distributed measurement transmission 165. At the exact same time, sampled well constituent information from a downhole sampling device may be conveyed to the surface equipment 150 over the thread 190 with digital transmissions 115. The surface equipment 150 may include different tools for dedicated types of communication with these different downhole devices. So, for example, in the present exemplary scenario, there is no concern over the temperature information being received and analyzed by a tool configured to analyze well constituent information due to the different channels employed. The tool of the surface equipment 150 which is configured to analyze the well constituent information communicates with the sampling device via digital transmission 115 that is not employed by the tool of the surface equipment 150 which obtains temperature information (via distributed measurement transmission 165).

Of course, distributed temperature information may be acquired from backscatter methods or techniques applied to the fiber optic thread 190 over its length as opposed to emerging from a single downhole location (e.g. the downhole device 180). The acquired data at the surface equipment may provide strain, vibration and other information in addition to temperature. Regardless of the information and origin, the distributed measurement transmission 165 is ultimately managed by a distributed measurement tool of the surface equipment that is dedicated to this transmission channel.

Referring now to FIG. 2A, a perspective view of embodiments of a surface coupler 201 and a downhole coupler 210 are shown as they might appear to an operator assembling the system 100 of FIG. 1. In this view, the jacketed fiber optic thread 190 suitable for downhole use runs between the common fittings 230, 270 of the couplers 201, 210.

With added reference to FIG. 2B, inside the body of each coupler 201, 210, fiber optics are merged. Due to location and usage, the couplers 201, 210 may have different temperature ratings and other distinctions. Nevertheless, in support of two way communications, separate fiber optic passages 205, 209 emerge from surface features and come into interface with one another and with the thread 190 within the body of the surface coupler 201. Thus, as the thread 190 emerges from the surface common fitting 230, it carries downlink light 140 on a dedicated wavelength channel from a surface fiber optic light transmitter 229. However, the thread 190 also serves as a platform for uplink light 160 of a different dedicated wavelength channel back to the other passage 209 in communication with a surface receiver 227.

As with the surface components, separate downhole fiber optic passages 215, 219 emerge from downhole features, for example in communication with a downhole tool 275 of the device 180 of FIG. 1. Again though, these separate passages 215, 219 come into interface with one another and the fiber optic thread 190 within the body of the downhole coupler 210. Thus, as the thread 190 emerges from the downhole common fitting 270, it carries uplink light 160 from a downhole transmitter 279 while also serving as a platform for downlink light 140 headed toward the downhole receiver 277.

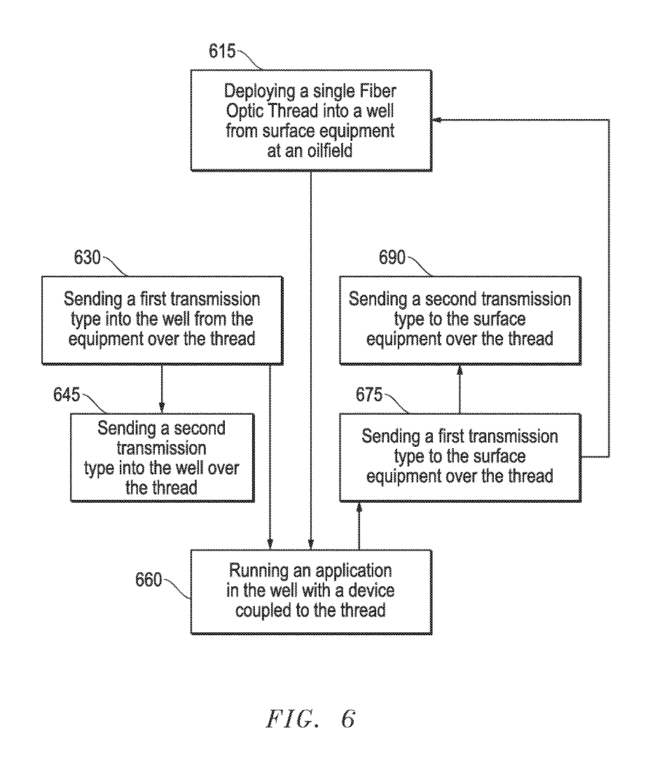

Continuing with reference to FIG. 2A, the fiber optic thread 190 may be jacketed as indicated to withstand a downhole environment. Additionally, the fiber itself may be multimode or single-mode and of a low or high temperature rating (e.g. below or over 150° C.). Further, the passages 105, 109 and/or 215, 219 illustrated in FIG. 2B may be incorporated directly into or coupled to a single module-type package that includes the transmitter 229, 279 and the receiver 227, 277 for ease of assembly, perhaps at the oilfield 500 (see FIG. 5). Thus, operators may have some flexibility when determining the necessary length and assembly of the overall system 100 for the application to be run.

Referring more specifically now to FIG. 2B, a schematic view of the system 100 of FIG. 1, is shown detailing a two-way communications platform for the transmissions 115, 125, 135, 145, 155, 165 by way of the couplers 201, 210 of FIG. 2A. It is worth noting that not all communications may require two-way support. Indeed, embodiments described further below may utilize alternate platforms where one or more transmissions 115, 125, 135, 145, 155, 165 are not supported in both directions. Nevertheless, the present two-way transmissions platform may be of benefit for many applications.

Continuing with reference to FIG. 2B, a schematic view of the system 100 is shown with surface equipment 150 and a downhole device 180. The surface equipment 150 includes a surface assembly 225 with a fiber optic light transmitter 229, receiver 227 and other features for positioning at an oilfield 500 such as that depicted in FIG. 5. The downhole device 180, for locating in a well 580, similarly includes a downhole tool 275 with its own fiber optic light transmitter 279 and receiver 277 (again see FIG. 5). Notably though, the system 100 also includes a single fiber optic thread 190 to allow for two-way transmissions thereover. Specifically, a single thread 190 may be run through a well 580, perhaps through several thousand feet of coiled tubing 510 (again see FIG. 5). As described above, this may be achieved through use of uphole 201 and downhole 210 couplers.

Each coupler 201, 210 may be equipped with a common fitting 230, 270 for securing the single thread 190. Further, the uphole coupler 201 includes a dedicated downlink passage 205 coupled to the light transmitter 229 and a dedicated uplink passage 209 coupled to the receiver 227. Similarly, the downhole coupler 210 includes a dedicated downlink passage 215 coupled to a receiver 277 and a dedicated uplink passage 219 coupled to a fiber optic transmitter 279. Ultimately, this means that downlink fiber optic light 140 may pass from the uphole fiber optic light transmitter 229 and into the shared fiber optic thread 190 eventually emerging at the downhole receiver 277 via the couplers 201, 210. As noted, the thread 190 is shared for two-way communications as described further below. Thus, uplink fiber optic light 160 may simultaneously be transmitted from the downhole fiber optic light transmitter 279 and into the thread 190 eventually emerging at the uphole receiver 227 via the couplers 201, 210. As a practical matter, this means that a surface assembly 225 of the surface equipment 150 may send data to a downhole tool 275 and the tool 275 may send data back to the assembly 225 over the very same fiber optic thread 190, simultaneously.

Keep in mind that for embodiments herein, there may be a host of different surface assemblies at the surface equipment 150. Similarly, there may be a variety of different tools at the downhole device 180. Thus, for the embodiment depicted in FIG. 2B, two way communication between one particular assembly 225 and a particular tool 275 is illustrated. Thus, the transmissions in either direction 140, 160 may all be considered to be of the same type (e.g. digital transmissions 115 as shown in FIG. 1).

The above described couplers 201, 210 allow for the passage of fiber optic light 140, 160 in both directions over the thread 190 at the same time. For example, the passage 205, 215 supporting downlink light 140 need not be structurally maintained separate and apart from the passages 209, 219 supporting uplink light 160 throughout the entire length of the system 100. Instead, within the uphole coupler 101, the uphole passages 205, 215 may be brought to interface with one another and physically merge with the single fiber optic thread 190. Similarly, within the downhole coupler 210, the downhole passages 215, 219 may also be brought into physical interface with one another and merge with the same thread 190 at the downhole end thereof.

Unlike electrical current, or other forms of data transfer, merging the optical pathways of both the downlink light 140 and uplink light 160 into the same shared thread 190 does not present an interference issue. That is, the two different lights 140, 160, each headed in the opposite directions do not impede one another. Of course, the same would be true for different light types headed in the same direction as detailed further below.

Other measures may be taken to ensure that the downlink light 140 reaches the downhole receiver 277 and the uplink light 160 reaches the uphole receiver 227. As suggested above, these measures may include tuning the receivers 227, 277 to particular wavelengths of light detection or outfitting each receiver 227, 277 with filters to substantially eliminate the detection of unintended light or both. For example, in one embodiment, where distributed measurements are involved, the downlink light 140 may be emitted by the uphole transmitter 229 at 1550 nm of wavelength whereas the uplink light 160 may be emitted by the downhole transmitter 279 at a 1310 nm wavelength. In this case, the transmitters 229, 279 may be conventional laser diodes suitable for emitting such wavelengths. Regardless, even if 1550 nm light 140 from the uphole transmitter 229 reflects back toward the uphole receiver 227, detection thereof may be substantially avoided due to tuning of the receiver 227 to receive 1310 nm light and filter out 1550 nm light. Alternatively, one or more optical filters may be used to minimize the amount of reflected light that reaches the receiver.

Even the use of wavelengths that are 200 or more nm apart in wavelength may further aid in avoiding such crosstalk detections by the receiver 229. Indeed, in one embodiment, the wavelengths may be even further separated, for example with the uplink light 160 being 810 nm in contrast to the downlink light 140 of 1550 nm (or vice versa). Of course, in this same embodiment, the downhole receiver 177 is afforded the same type of tuning and/or filtering to help ensure proper detection of 1550 nm light 140 to the substantial exclusion of 1310 nm light.

Continuing with reference to FIG. 2B, the couplers 201, 210 may be of a wavelength division multiplexing (WDM) configuration which is particularly adept at avoiding crosstalk as described above. The couplers 201 may have combined functionality such as laser and photo-detecting capabilities. Regardless, in addition to tuning and filtering, the type of coupler 201, 210 may also help ongoing communications. This may be of particular importance depending on the age of the system 100 and thread 190 in particular. That is, as signal attenuation becomes greater over the life of the fiber optic thread 190, the strength of the fiber optic signals therethrough may naturally reduce. However, this attenuation does not necessarily apply to light that is reflected through a coupler 201, 210 and back toward its origin (e.g. light 140 from the uphole transmitter 229 and back to the uphole receiver 227). Thus, the use of a WDM coupler 201, 210 to minimize the amount of such reflected light and insertion loss in combination with filtering and tuning of the receiver 227 may substantially eliminate the detection of crosstalk.

With added reference to FIG. 1 and as noted above, the illustrated two way communication of FIG. 2B may be of one particular transmission type (e.g. digital 115). However, other transmission types 125, 135, 145, 155, 165 may occur at the same time in both directions over the same thread 190 between different (or even the same) surface assemblies and downhole devices. Thus, additional dedicated wavelength tuning in other ranges and other related measures may be employed to help further bolster the integrity of such communications. Regardless, the system 100 may now support multiple data acquisition platforms at the oilfield, perhaps in various locations that are in real-time communications with any number of different downhole tools over a single fiber optic thread 190.

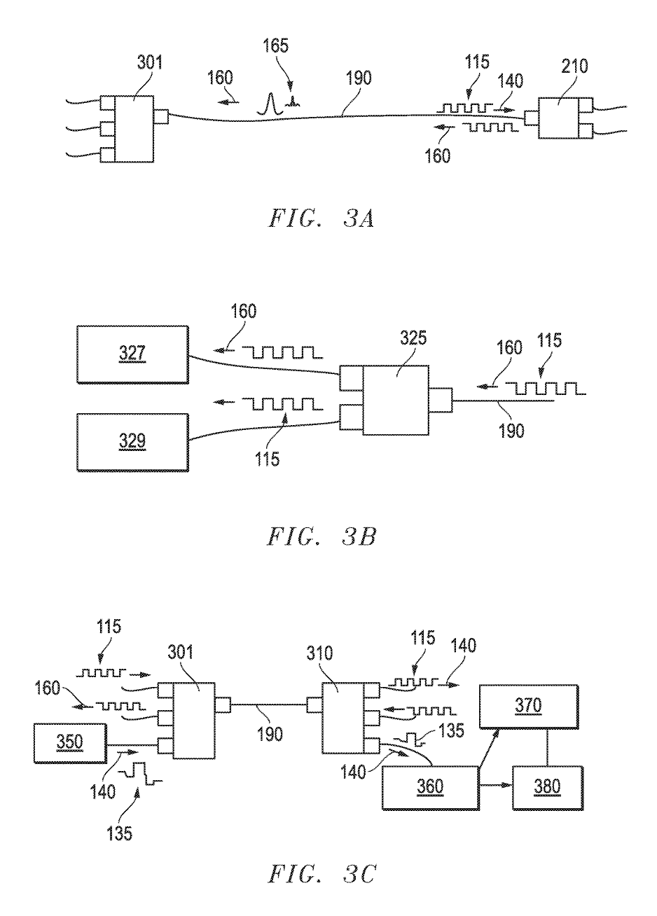

Referring now to FIG. 3A, a schematic view of an embodiment of a system with a single fiber optic thread 190 supporting multiple transmission types 115, 165, is shown which includes one-way transmissions (e.g. 165). More specifically, the downhole coupler 210 is configured for two way communication (140, 160) with an uphole coupler 301. Thus, two-way communications via digital transmission 115 are supported between a downhole tool and a surface assembly. However, additional one-way (160) communications are also supported. Specifically, in the embodiment shown, analog transmissions 165 are routed through the uphole coupler 301 alone. For example, this may occur when the condition of the fiber 190 is monitored for DTS type of information. Of course, in other embodiments, the reverse may be true with more transmission types being directed uphole over the thread 190 than downhole.

Referring now to FIG. 3B, a schematic view of another embodiment of a system with a single fiber optic thread 190 supporting multiple transmission types is shown. However, in this embodiment, the transmissions 115 may be split and routed to different destinations. That is, a splitter 325 may obtain one type of transmission 115 from an uphole coupler and direct the information to two different surface acquisition systems 327, 329. So, for example, where the transmission 115 originates from a logging tool in a well, it may be useful for more than one surface assembly or acquisition system 327, 329. These systems 327, 329 may in turn use the information acquired from the transmission 115 in directing downhole applications with downhole tools over the same thread 190.

Referring now to FIG. 3C, a schematic view of another embodiment of a system with a single fiber optic thread 190 is shown where multiple transmission types 115, 135 are utilized including optical power transmissions 135. In this scenario, two way communications are supported 140, 160 in terms of telemetry (e.g. via digital transmission 115). However, an additional transmission is directed through the uphole coupler 301 in the form of optical power 135. So, for example, a laser may send a modulated, constant or large amount of optical power 135 over the thread 190 and to a downhole coupler 310 where one of the passages directs this transmission 135 to a collector device 360 with photovoltaic collecting capacity. Thus, downhole tools 380 may be powered. Similarly, electrical power may also be routed to a transceiver or other device 370 that makes use of other transmissions 115.

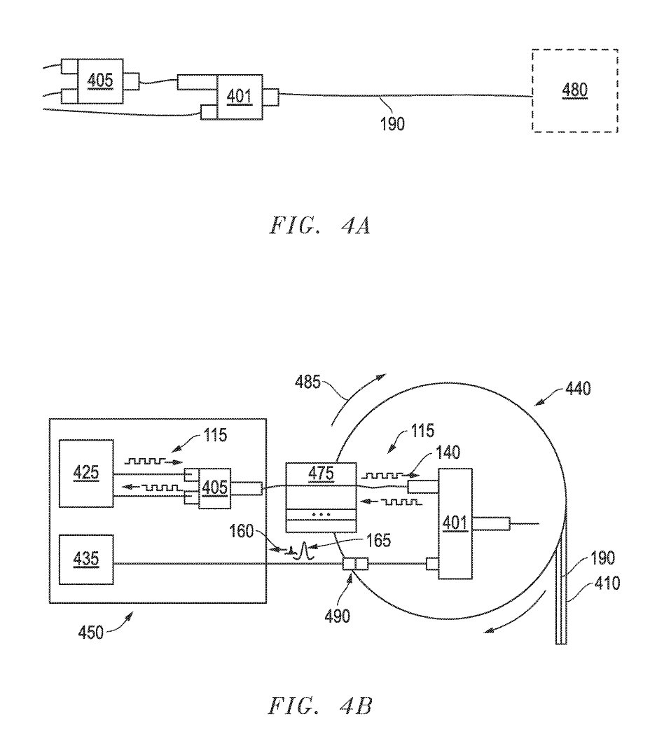

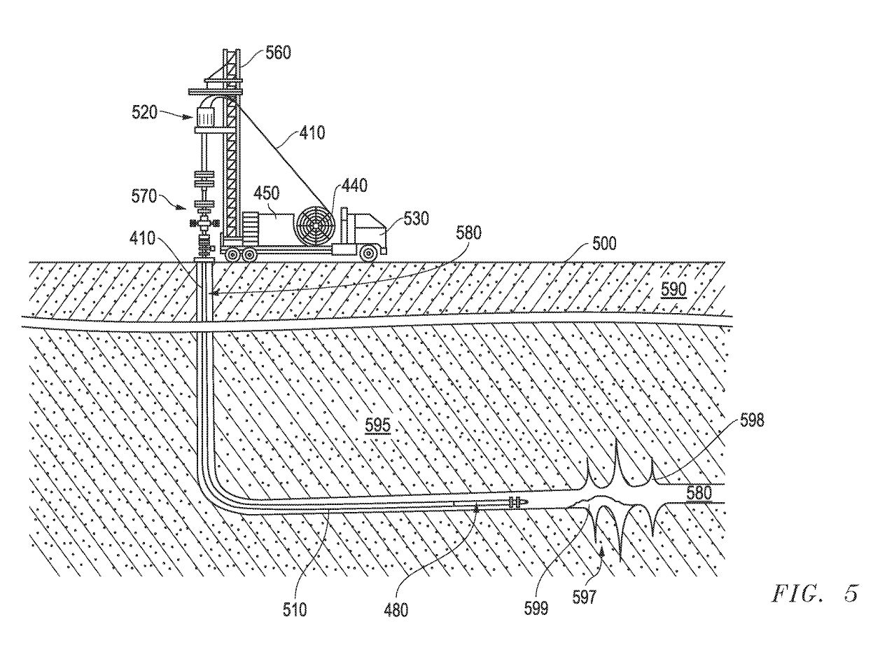

Referring now to FIG. 4A, a schematic view of another embodiment of a system with a single fiber optic thread 190 supporting multiple transmission types is shown. In this embodiment, couplers 401, 405 are placed in series for unique channel segregation. For example, certain transmissions may be grouped together for managing in one fashion whereas others may require a separate form of management. This may be illustrated with reference to FIG. 4B and the schematic representation of data acquired and managed during a coiled tubing application. Specifically, FIG. 4B illustrates coiled tubing 410 which accommodates the single thread 190 to support transmissions as detailed hereinabove. However, a coiled tubing application generally involves utilizing a reel 440 to rotate (arrow 485). In this way, coiled tubing 410 on the reel may be lowered into a well at an oilfield (or retrieved from the well).

Because of the movement of the reel 440 of FIG. 4B, determinations of how to manage transmissions 115, 165 should be made. For example, a rotary joint collector 475 may be used to support substantially continuous communications in spite of the moving reel 440. Such collection methods or techniques are detailed in U.S. application Ser. No. 14/873,083 for an Optical Rotary Joint in Coiled Tubing Applications, as referenced herein. Thus, as illustrated certain transmissions 115 may be continuously passed from a first uphole coupler 401, through the collector 475 and on to another uphole coupler 405 of the surface equipment 450. A first assembly 425 of the equipment 450 may manage this type of data for various application purposes. However, there may be a desire for greater accuracy of information than that available through the collector 475. Once more, where the information is not necessarily required on a continuous basis, such as DTS information, it may be more desirable to disconnect a connector 490 to the first coupler 401 when the reel 440 is to be rotated 485. Thus, as shown, analog transmissions 165 may be directed to a second assembly 435 of the equipment 450 when the connector 490 is connected to the reel 440. So, for example, the condition of the fiber 190 may be checked both before and after rotating 485 the reel 440 to place the coiled tubing 410 in the well for an application.

Referring now to FIG. 5, an overview of an oilfield 500 is shown with the coiled tubing 410 of FIG. 4B in a well 580 for an application utilizing a single fiber optic thread system supporting multiple transmission types. Additionally, with added reference to FIG. 4B, two-way telemetric communications may also be supported over the single fiber optic thread 190. The oilfield 500 accommodates surface equipment that includes an uphole assembly 450 that is linked to a downhole assembly 480 that may employ an application tool. In the embodiment shown, the application tool is a cleanout tool, for example, directed at debris 599. The tool may be directed by the uphole assembly 450 in the form of a control unit to effect debris removal and leave perforations 598 at a production region 597. With two-way communications available, the tool may provide feedback information back to the control unit 450. Once more, this information may be provided via multiple transmission types as detailed herein, for example, to provide information regarding the application, tool, well conditions, or other downhole information.

Both of the noted two-way communications and the differing transmission types may take place over a single fiber optic thread 190 of minimal profile. Thus, clearance within a flow path of the coiled tubing 410 may be sufficient for fluid flow capable of maintaining integrity of the coiled tubing 410 as well as delivering fluid for the cleanout of the indicated debris 599 or for other wellbore applications, such as wellbore stimulation applications, requiring the delivery of fluid along the flow path of the coiled tubing 410, as will be appreciated by those skilled in the art. Additionally, in such an embodiment, the fiber optic nature of communications may be less susceptible to damage where the cleanout fluid is of an acid nature.

As shown in FIG. 5, the surface equipment includes a mobile coiled tubing truck 530 carrying a reel 440 of tubing 410 that is supported by a mobile rig 560 and forcibly driven through a pressure control system 570 by a conventional gooseneck injector 520. In this way, the coiled tubing 410 and application tool may be advanced several thousand feet through the well 580 traversing multiple formation layers 590, 595 before reaching the targeted application site. Nevertheless, the single thread nature of the two-way communications provided through the coiled tubing 410 may help to keep the total weight of the deployed tubing 410 to a minimum as well as the cost. That is, in place of multiple threads for two-way communications through the coiled tubing 410, a single thread may be utilized as detailed above.

With added reference to FIG. 4B, use of a single thread 190 means that there is also an added degree of reliability in the communications due to the reduced number of terminations. Specifically, while four or more terminations may be utilized in a conventional multi-thread embodiment, fiber optic terminations may be reduced to as few as two in single thread embodiments described herein. However, in other embodiments, the fiber optic thread 190 may be interrupted with a fiber optic rotating joint 490, for example, at the coiled tubing reel 440 or downhole so as to allow for flexibility in movement during deployment of the coiled tubing 410.

While an exemplary coiled tubing application is illustrated at FIGS. 4A, 4B and 5, other systems may make use of multiple transmission types supported over single thread fiber optics. For example, substantially permanent installations such as flowline in a well, pipeline across an oilfield, production tubing and other tubular hardware within permanent completions may accommodate are utilize such a thread for multiple transmission types.

Referring now to FIG. 6, a flow-chart summarizing an embodiment of an application utilizing a system in a well is illustrated where a single fiber optic thread accommodates multiple fiber optic transmission types. Specifically, upon deploying the thread into the well from oilfield surface equipment as indicated at 615, first and second transmission types 630, 645 may be sent downhole over the thread. By the same token, an application that is run in the well by a device that is also coupled to the thread as noted at 660 may be followed up with first and second transmission types from the device back to the surface equipment (see 675, 690). Thus, the thread not only supports multiple types of transmissions but the transmissions may be in both directions.

Of course, transmissions of different types may not necessarily be sequential in a given direction. For example, one type of transmission may be sent into the well as indicated at 630 followed by the running of an application as noted at 660. This may be followed by another transmission of another type directed at the surface equipment as indicated at 675. This, in turn may be followed by yet another type of transmission directed at the surface equipment (see 690) or not (see the bypass from 675 to 615). Regardless, so long as multiple transmission types may be accommodated over the single fiber optic thread, appreciable benefit may be realized. This may include sequential or simultaneous transmission types in one or both directions.

The preceding description has been presented with reference to presently preferred embodiments. Persons skilled in the art and technology to which these embodiments pertain will appreciate that alterations and changes in the described structures and methods of operation may be practiced without meaningfully departing from the principle, and scope of these embodiments. Regardless, the foregoing description should not be read as pertaining only to the precise structures described and shown in the accompanying drawings, but rather should be read as consistent with and as support for the following claims, which are to have their fullest and fairest scope.

We claim:

1. A system for use with a well at an oilfield and comprising:
surface equipment positioned at the oilfield;
a downhole device positioned in the well; and
a fiber optic thread coupled to the surface equipment and the downhole device, the thread configured to accommodate a first fiber optic transmission to one of the equipment and the device and configured to accommodate a second fiber optic transmission to one of the equipment and the device, the first and second transmissions of different transmission types.

2. The system of claim 1 wherein the transmissions are fiber optic transmissions selected from a group consisting of digital transmissions, analog transmissions, wavelength shifting transmissions, phase changing transmissions, distributed measurement transmissions and optical power transmissions.

3. The system of claim 2 wherein one of the first and second fiber optic transmissions are the optical power transmissions, the system further comprising a photovoltaic collector coupled to the downhole device.

4. The system of claim 1 further comprising:
a surface coupler coupled to the thread and to uplink and downlink passages to the surface equipment; and
a downhole coupler coupled to the thread and to uplink and downlink passages to the downhole device, the passages to support two way communications in uplink and downlink directions between the equipment and the device over the thread.

5. The system of claim 4 wherein the couplers are wavelength division multiplex devices to manage wavelengths of the transmissions in the uplink and downlink directions.

6. The system of claim 5 wherein the wavelengths are determined by one of the transmission type and the link direction.

7. The system of claim 1 further comprising a splitter coupled to the fiber optic thread to route one of the first and second transmission types to two different destinations.

8. The system of claim 7 wherein the destinations accommodate different surface acquisition systems.

9. A system for use at an oilfield, the system comprising:
surface equipment positioned at the oilfield; and
a fiber optic thread coupled to the surface equipment to accommodate two different fiber optic transmission types from two different assemblies of the surface equipment.

10. The system of claim 9 wherein the transmissions are fiber optic transmissions selected from a group consisting of digital transmissions, analog transmissions, wavelength shifting transmissions, phase changing transmissions, distributed measurement transmissions and optical power transmissions.

11. The system of claim 9 wherein one of the assemblies comprises a distributed measurement tool.

12. The system of claim 9 further comprising a tubular structure to accommodate the fiber optic thread, the tubular structure selected from a group consisting of coiled tubing, slickline, wireline, flowline, pipeline, permanent downhole completions, cables for electrical submersible pumps and production tubing.

13. A method of employing a system in a well at an oilfield, the method comprising:
deploying a single fiber optic thread from surface equipment at the oilfield and into the well, the fiber optic thread coupled to a downhole device for an application in the well;
sending a first fiber optic transmission type over the fiber optic thread from one of the surface equipment and the downhole device;
sending a second fiber optic transmission type over the fiber optic thread from one of the surface equipment and the downhole device, the first and second transmissions of different transmission types.

14. The method of claim 13 wherein the transmissions are fiber optic transmissions selected from a group consisting of digital transmissions, analog transmissions, wavelength shifting transmissions, phase changing transmissions, distributed measurement transmissions and optical power transmissions.

15. The method of claim 13 further comprising employing at least one of the transmission types for two way communications between the surface equipment and the downhole device.

16. The method of claim 13 further comprising sending a third fiber optic transmission from one of the surface equipment and the downhole device, the third fiber optic transmission being a one-way transmission.

17. The method of claim 13 further comprising:
receiving a fiber optic transmission type at the surface equipment; and
splitting the transmission for relay to multiple surface acquisition systems at the oilfield.

18. The method of claim 13 wherein at least one of the transmission types is optical power, the method further comprising supplying power to the downhole device by way of the optical power.

19. The method of claim 13 further comprising receiving different fiber optic transmission types at the surface equipment through different couplers of the surface equipment in series.

20. The method of claim 19 wherein the deploying of the fiber optic thread into the well comprises deploying coiled tubing into the well in conjunction with the thread, the receiving of the different fiber optic transmission types comprising:
receiving a first fiber optic transmission type through a rotary joint on a substantially continuous basis during the deploying of the coiled tubing; and
receiving a second fiber optic transmission type through a connector on a periodic basis when the coiled tubing is not being deployed.
